(19) United States
(12) Patent Application Publication
(10) Pub. No.: US 2003/0117424 A1
(43) Pub. Date: Jun. 26, 2003

(54) Colored rotation spherical material, manufacturing method therefor, and display device

(75) Inventors: Masaru Kinoshita, Kawasaki (JP); Naoyuki Hayashi, Kawasaki (JP); Mitsuo Ozaki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/278,865

(22) Filed: Oct. 24, 2002

(30) Foreign Application Priority Data
Dec. 21, 2001 (JP) 2001-390134

(51) Int. Cl. G09G 5/00

(52) U.S. Cl. 345/700

(57) ABSTRACT

A colored rotation spherical material is configured so as to have two parts different from each other in color, such as a white part and a black part, and an optical reflective region between the two parts, such as a reflective layer. With this constitution, since the reflective layer reflects light which is usually absorbed on the black part, and the white part scatters the reflected light again, whiteness degree and reflectance increase.

### CROSS-REFERENCE TO RELATED APPLICATIONS

This application is based upon and claims priority of Japanese Patent Application No. 2001-390134, filed on Dec. 21, 2001, the contents being incorporated herein by reference.

### BACKGROUND OF THE INVENTION

1. Field of the Invention

The present invention relates to a colored rotation spherical material, a manufacturing method for the colored rotation spherical material, and a display device. The surface of the colored rotation spherical material is defined by using colors different from one another, and the colored rotation spherical material rotates under influence of electric field to show a surface with a corresponding color.

2. Description of the Related Art

A development of a thin and lightweight display excellent in portability has been attracting attention recently as a mobile information terminal and an advanced information communication network have developed. Especially, expectation for a display device, which displays an image by changing optical absorbing characteristic and optical reflection characteristic under an electric field, has as much flexibility as paper, and allows rewriting electronic information easily, such as so-called electronic paper, a paper-like display, and digital paper has been increasing.

As a display element which changes the optical absorbing characteristic and the optical reflection characteristic under an impressed electric field, there exist a microcapsule containing a rotation spherical material formed by combining hemispheres different from each other both in color and electric characteristics along with dielectric fluid, a microcapsule disclosed in Japanese Patent Application No. Sho 62-244679 (Laid-Open No. Sho 64-86116), which includes colored solvent including diffused electrophoretic spherical materials, and a liquid crystal/polymer composite film including dichroic dye and smectic liquid crystal.

Since these display elements have features such as a memory characteristic, which maintains image information without power supply, and a reflective display characteristic, and can be formed on a PET film including electrodes, they are expected to be used for a thin, lightweight, and bendable sheet type display device as a replacement of paper.

Especially a display device described in U.S. Pat. Nos. 4,126,854 and 4,143,103, which uses a colored rotation spherical material including hemispheres different in color and electrostatic property are known as a display device excellent in contrast property compared with other types. This display device includes a light transparent layer as a base including multiple cavities filled with a dielectric liquid, and rotation spherical materials each accommodated in these cavities. Since the rotation spherical material is a colored rotation spherical material including two regions different in color and electrostatic property as one spherical material, electrophoresis and a rotating motion of the spherical material are brought about by impressing electric field, thereby achieving image display.

These display devices are manufactured by using dielectric polymer such as silicone rubber as the base material, and dimethyl silicone oil as the dielectric liquid. Specifically, spherical materials including two or more regions different in color are diffused in the two-component silicone rubber. Each region in the spherical material is composed of a coloring material and a resin. Then, after the silicone rubber is formed as a sheet, the silicone rubber is hardened at room temperature or by heating. Then, the hardened rubber is immersed into dimethyl silicone oil, and consequently a microcapsule where the silicone oil surrounds the spherical material is formed. Finally, a display device of rotating spherical material type is completed.

As the manufacturing methods and the materials for the colored rotation spherical material, in (1) U.S. Pat. No. 5,262,098, after two types of melted wax spherical materials in color different from each other are combined, and are formed as a sphere by surface tension followed by hardening the sphere. As the materials, carnauba wax, carbon black, and titanium oxide are used. In (2) Japanese Patent Application Nos. Hei 9-246738 (Laid-Open No. Hei 11-085067), and Hei 9-246739 (Laid-Open No. Hei 11-085068), metal, carbon black, or antimony sulphide is vapor-deposited on the surface of a spherical material made of glass or resin. In (3) Japanese Patent Application Nos. Hei 9-248527 (Laid-Open No. Hei 11-085069), and Hei 9-330135 (Laid-Open No. Hei 11-161206), a spherical material made of a light-sensitive material is color-developed by exposing, developing, and fixing. As the materials, zinc oxide (toner is used as the color developing agent) and hydrophilic polymer (silver halide is used as the color developing agent) are used.

It is demanded to reduce the diameter of the colored rotation spherical material for increasing resolution of the display element in view of requirement for increasing the display quality as high as photocopy. However, there is essentially such a problem that display contrast decreases as the diameter is reduced when any one of the colored rotation spherical materials manufactured in the methods described above is used. Namely, since volumes for the colored regions decrease as the diameter of the colored rotation spherical material decreases, optical reflection and scattering characteristics of the spherical material change on a white part particularly for the colored rotation spherical material in black and white. As a result, even when a pigment with a high whiteness degree such as titanium oxide is used as the white material, it is impossible to restrain the reduction of degree of whiteness and contrast ratio.

### SUMMARY OF THE INVENTION

The present invention is devised in view of the foregoing, and it is an object of the invention to provide a colored rotation spherical material which secures sufficient lightness even when the diameter of the spherical material is reduced, a manufacturing method for the colored rotation spherical material which clearly distinguishes borders between individual colored parts and a reflective material, and simultaneously controls volume ratio among the individual colored parts, and the reflective material, and a display device which uses this colored rotation spherical material as a display element for increasing the resolution of a displayed image.

The present inventor has reached the following aspects of the present invention as a result of intensive study.

A colored rotation spherical material according to the present invention includes multiple regions on a surface different from one another in color and electrostatic property, and an optical reflective region inside for enhancing reflection from the inside in one region of the multiple regions. The spherical material rotates under influence of an electric field so as to present a surface with a corresponding color.

A manufacturing method for a colored rotation spherical material according to the present invention includes the steps of preparing two thermoplastic resin sheets different from each other in color, forming an optical reflective material on one surface of at least one of the thermoplastic resin sheets, forming a multilayer resin sheet by integrally adhering the two thermoplastic resin sheets to each other so as to hold the reflective material between them, cutting the multilayer resin sheet into chips, and applying heat treatment to the chip-shape cut pieces to form a sphere.

In addition, another aspect of the manufacturing method for a colored rotation spherical material according to the present invention includes the steps of forming a reflective resin sheet by diffusing metal fine spherical materials in thermoplastic resin, preparing two thermoplastic resin sheets different from each other in color, forming a multilayer resin sheet by integrally adhering the two thermoplastic resin sheets to each other so as to hold the reflective resin sheet between them, cutting the multilayer resin sheet into chips, and applying heat treatment to the chip-shape cut pieces to form a sphere.

Further, a display device according to the present invention includes a pair of opposing electrode substrates including at least one transparent electrode substrate, and a disperse system which is sealed between the pair of opposing electrode substrates, and includes the colored rotation spherical materials configured above.

### BRIEF DESCRIPTION OF THE DRAWINGS

FIG. 1 is a schematic view showing an outlined structure of a colored rotation spherical material according to one embodiment of the present invention;

FIGS. 2A to 2C are schematic views showing a manufacturing method for the colored rotation spherical material according to the present embodiment along its process sequence;

FIGS. 3A to 3C are schematic views showing another manufacturing method for the colored rotation spherical material according to the present embodiment along its process sequence;

FIG. 4 is a characteristic chart showing a result of measuring reflectance on a white side of the colored rotation spherical material according to the present embodiment;

FIG. 5 is an outlined sectional view showing a display device according to one embodiment of the present embodiment; and

FIGS. 6A to 6C are schematic views showing a rotation state of the colored rotation spherical materials under impressed voltages in the display device according to the present embodiment.

### DETAILED DESCRIPTION OF THE PREFERRED EMBODIMENTS

The following will describe preferred embodiments to which the present invention is applied in detail with reference to the accompanying drawings.

Basic Principle of the Present Invention

First, a basic principle of the present invention is described.

When a colored rotation spherical material includes multiple colored parts different in lightness and electrostatic property, such as two colored parts including a black part and a white part, whiteness degree of the white part decreases as the diameter of the spherical material decreases because light (usually ambient light) entering into the white side on the spherical material is not sufficiently diffused in the material, thus enters into the opposing black part, and is consequently absorbed there.

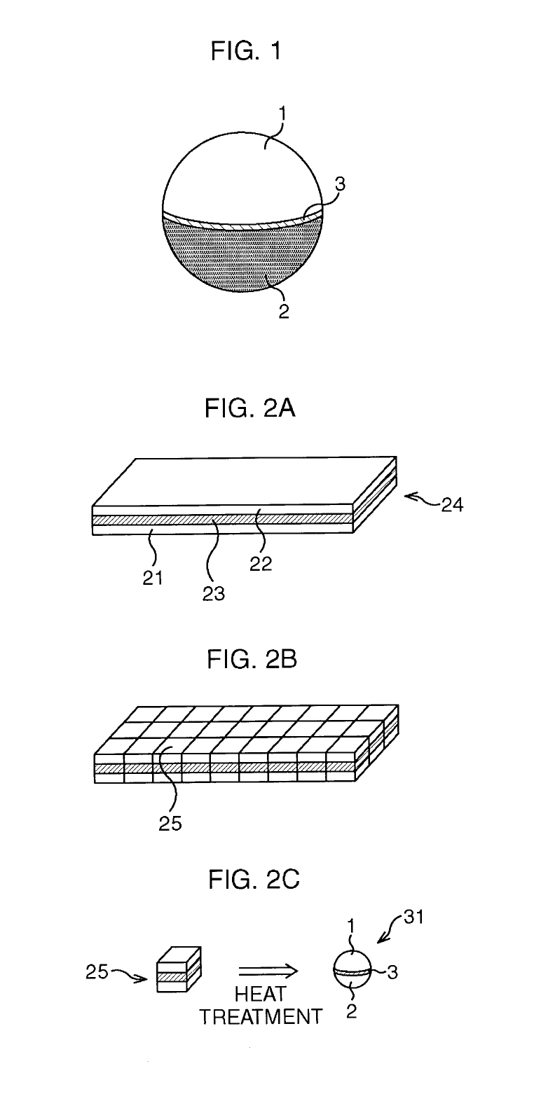

A colored rotation spherical material of the present invention includes an optical reflective region inside so as to enhance the reflection from the inside in one region of the multiple regions. Specifically, a reflective layer 3 as the optical reflective region is provided between two colored regions different from each other in color, a white part 1 and a black part 2 as shown in FIG. 1. With this constitution, since light which is usually absorbed by the black part 2 is reflected on the reflective layer 3, and then is scattered again in the white part 1, whiteness degree and reflectance increase.

The reflective layer 3 is always exposed on the equator of the colored rotation spherical material in the example in FIG. 1, and this constitution is the most practical. However, it is also possible to constitute the colored rotation spherical material such that the optical reflective region is not exposed on the surface of the sphere at all, and is completely included inside depending on the heating for finishing the colored rotation spherical material as a sphere as described later. This constitution similarly provides an excellent effect as the colored rotation spherical material with the exposed reflective layer 3.

It is difficult to manufacture the colored rotation spherical material in two colors including the optical reflective region as described above in a conventional method where materials are processed while they have relatively low viscosity during processing.

In the present invention, a manufacturing method is applied such that after thermoplastic resin sheets in two colors such as a white resin sheet and a black resin sheet are adhered to each other, they are cut into chips, and then are heat-treated so as to be formed as spheres.

Namely, first, a white resin sheet 21 and a black resin sheet 22 are adhered to each other while a reflective layer 23 having optical reflective function is interposed between them as shown in FIG. 2A. Then, the integrated multilayer resin sheet 24 is cut into chip-shape cut pieces 25 as shown in FIG. 2B. Then, the cut pieces 25 are heat-treated to form spheres as shown in FIG. 2C. In this way, a colored rotation spherical material 31 is manufactured such that the borders between the black part 1 and the reflective layer 3, and the white part 2 and the reflective layer 3 are distinct, and simultaneously a volume ratio among the white part 1, the black part 2, and the reflective layer 3 is controlled.

The multilayer resin sheet 24 including the reflective layer can be manufactured by, after a metal thin film is vapor-deposited on one surface of the white resin sheet 21 or the black resin sheet 22, adhering this surface to the other black resin sheet 22 or the white resin sheet 21. Though the thin metal film may be vapor-deposited on the white resin sheet 21 or the black resin sheet 22, it is preferable to vapor-deposit on the white resin sheet 21 in consideration of adhesiveness and the smoothness of the interface between the colored part (the white part 1 or the black part 2) and the metal thin film, and in terms of increasing the reflection of incoming light from the white side.

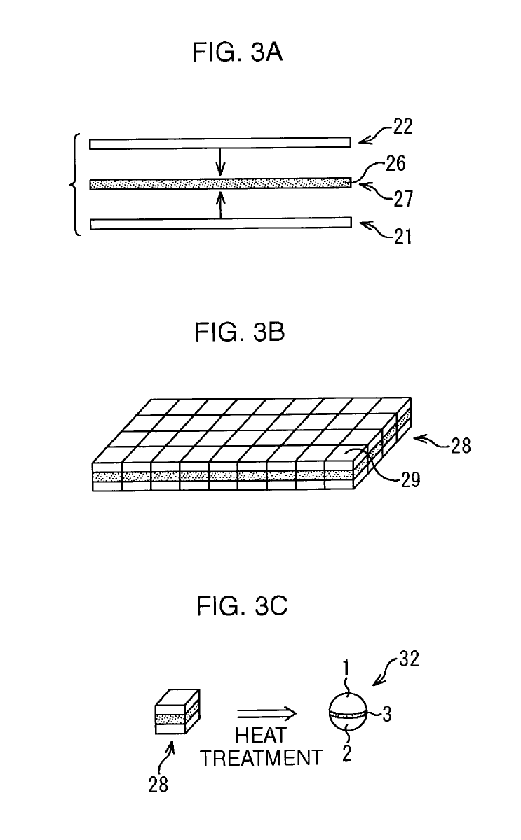

Alternatively, the black/white resin sheet including the reflective layer may be manufactured by preparing a reflective resin sheet 27 by diffusing metal fine spherical materials 26 in thermoplastic resin in advance as shown in FIG. 3A, adhering the white resin sheet 21 and the black resin sheet 22 to both sides of this reflective resin sheet 27, cutting the resultant integrated multilayer sheet 28 into cut pieces 29 in chip shape as shown in FIG. 3B, and subjecting the cut pieces to heat treatment to be formed as spheres as shown in FIG. 3C. In this way the colored rotation spherical material 32 is manufactured. In this case, though it is preferable that the thermoplastic resin used for the reflective resin sheet 27 be the same as base material resin of the colored parts, the thermoplastic resin is not limited to this resin, and may by any resin as long as it is compatible with the base resin material of the colored parts.

Though the reflective layer is often exposed on the surface of the colored rotation spherical material, it may not be exposed on the surface.

For example, when the multilayer sheet 24 or 28 is cut while it is heated to a temperature close to softening temperature of the resin, a shear drop is generated on a section, and thus the reflective layer is not exposed on the section of the cut piece. As a result, the reflective layer is not exposed on the surface of the colored rotation spherical material formed as a sphere by heat treatment afterward.

Also, when the reflective layer is a vapor-deposited film of metal, since the thickness of the film is extremely thin with respect to the diameter of the spherical material, the film may not be observed as an exposure of the reflective layer on the surface of the colored rotation spherical material.

It is preferable to use aluminum for forming the metal vapor-deposited film and the fine spherical materials in terms of specific gravity and reflectance. However, the material is not limited to aluminum, and it is also possible to use resin including arbitrary optical reflection feature inside as the reflective layer.

Embodiment of Manufacturing Method for Colored Rotation Spherical Material

Table 1 shows a composition of resin and additives serving as base materials of a typical black-and-white-colored rotation spherical material. The base materials with the same compositions are used in the following embodiments unless otherwise specified.

TABLE 1
Black/white base material compositions

| Name of material | Quantity | Remark |
|---|---|---|
| Base material | 90 wt % (white), | Polyester resin |
| resin | 93 wt % (black) | with Tm of 98° C. |
| Titanium oxide | 10 wt % | (White pigment) |
| Carbon black | 2 wt % | (Black pigment) |

[First Embodiment]

Titanium oxide and carbon black were respectively mixed with the base material resin with the compositions shown in Table 1 by kneading with a kneader, and colored black and white resins were prepared. Lumps of the resins in the both colors were rolled while being heated at 115° C., and consequently a white resin sheet and a black resin sheet with a thickness of about 12 μm were formed. A reflective layer with a thickness of about 100 nm was added by vacuum-depositing aluminum on the white resin sheet. The black resin sheet was adhered on the surface of the white resin sheet where the reflective layer had been vacuum-deposited while a pressure was being applied at 80° C. Consequently an integrated black/white resin sheet with a thickness of about 23 μm including the reflective layer was formed. Then, this resin sheet was chipped into a large number of square tiles by round blades provided at an interval of about 150 μm. The square tiles were diffused in silicone oil heated to 120° C. so as to apply heat treatment for 30 seconds, and consequently colored rotation spherical materials in black and white with a diameter of about 100 μm including the reflective layer were obtained.

To confirm an effect of adding the reflective layer, reflectance on the white side of the black/white integrated resin sheet was measured for a case with the reflective layer and a case without the reflective layer while the concentration of the white dye was set to 10 wt % or 2 wt %, and the thickness (the sheet thickness) of the black/white integrated resin sheet was changed.

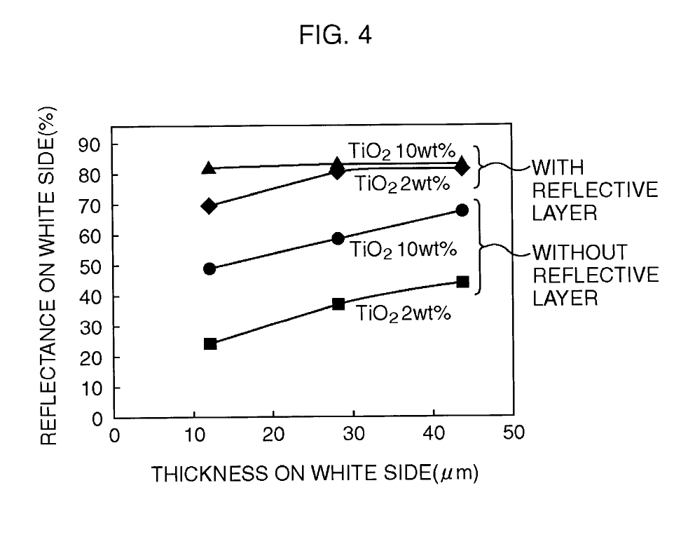

FIG. 4 shows the measured result. As shown in FIG. 4, it is observed that providing the reflective layer largely increases the reflectance on the white side, and this effect is especially remarkable when the pigment concentration is low. For example, while the sheet thickness of 44 μm is necessary for obtaining 70% of reflectance on the white side when the density of the white pigment concentration is about 10 wt % if the reflective layer does not exist, the sheet thickness can be reduced to about 12 μm even when the pigment concentration is reduced to 2 wt % if the reflective layer exists. Reducing concentration of pigment having high specific gravity improves specific gravity of the spherical materials affecting the display characteristics, and balance of them. Since the sheet thickness can be reduced, desired reflectance is obtained using display spherical materials with a smaller diameter, and thus the resolution can also be increased.

[Second Embodiment]

A white resin sheet and a black resin sheet with a thickness of about 10 μm were formed as in the first embodiment. Then, aluminum fine spherical materials with an average spherical material diameter of 2 μm was mixed with polyester serving as the base material resin by kneading with a kneader. Then, a resultant resin lump was rolled while being heated at 115° C., and consequently a resin sheet for a reflective layer with a thickness of about 4 μm was formed. The white resin sheet and the black resin sheet were adhered while they were pressed on the both surfaces of the resin sheet for a reflective layer at 80° C., and consequently an integrated black/white resin sheet with a thickness of about 23 μm including the reflective layer was formed. Then, this integrated black/white resin sheet was chipped, resultant chips were heat-treated, and consequently colored rotation spherical materials in black and white with a diameter of about 100 μm including the reflective layer were obtained as in the first embodiment.

[Third Embodiment]

In the present embodiment, a sheet-type display device provided with the black/white colored rotation spherical materials including the reflective layer according to the present invention is exemplified.

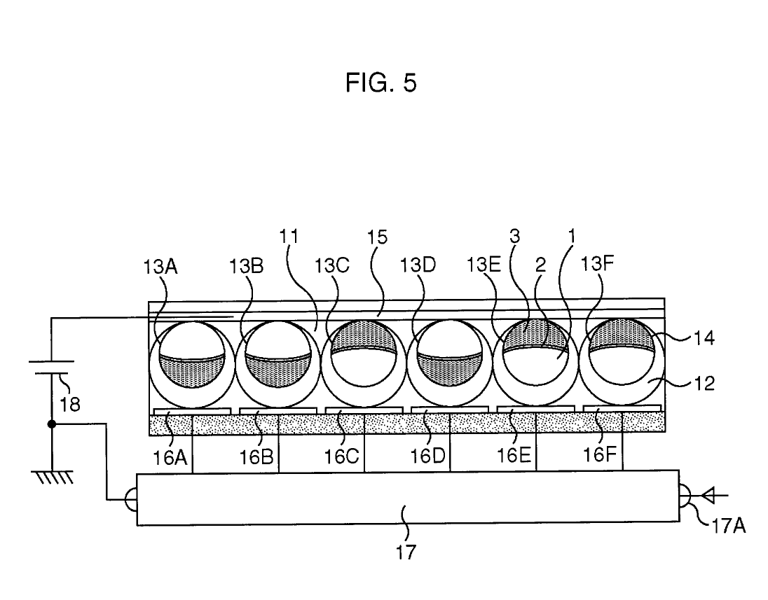

This sheet-type display device includes, as shown in FIG. 5, a sheet base material 11, a transparent common electrode 15, display electrodes 16A-16F, a drive circuit 17, and a power supply 18 for the drive circuit 17. The sheet base material 11 is optically transparent layer, and includes multiple cavities filled with dielectric translucent liquid 12 constituting a disperse system. The colored rotation spherical materials of the present invention (13A through 13F in the example in the drawing) are accommodated in these cavities. The transparent common electrode 15 is provided on a top surface of the sheet base material 11, and serves as an opposing electrode substrate. The display electrodes (16A through 16F in the example in the drawing) are provided on a bottom surface of the sheet base material 11 so as to oppose to the individual colored rotation spherical materials. The drive circuit 17 includes a signal input terminal 17A.

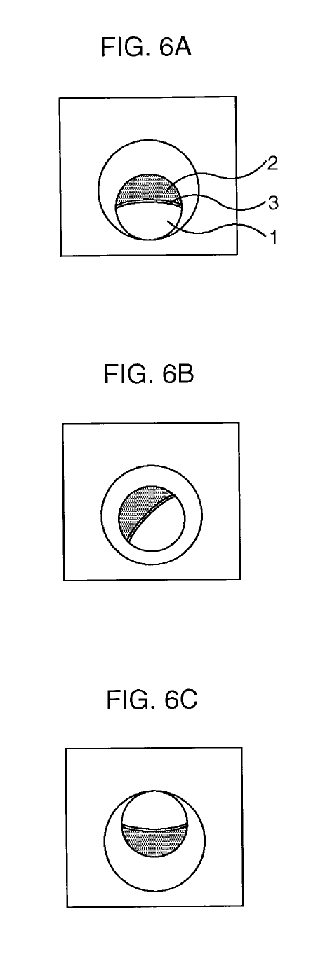

Since the colored rotation spherical material is a spherical material including two regions different in color and electrostatic property (a white part 14A and a black part 14B) with the reflective layer 3 between them, electrophoresis and a rotating motion of the colored rotation spherical materials are brought about when electric field is impressed between the transparent common electrode 15 and the individual display electrodes 16A to 16F by the power supply 18 and the drive circuit 17 as shown in FIGS. 6A-6C. Consequently an image can be displayed. FIG. 6A shows black display, FIG. 6B shows color change in progress, and FIG. 6C shows white display in the example in the drawing.

Two-component RTV silicone rubber KE106 (Shin-Etsu Chemical Co., Ltd.), which is liquid silicone to be hardened at room temperature, was used as the base material to manufacture the sheet base material 11. The colored rotation spherical material in two colors of black and white including the reflective layer 3 manufactured in the first or second embodiment was used as the colored rotation spherical material. Silicone oil SH200, 10cS (Dow Corning Toray Silicone Co., Ltd.) was used as the translucent liquid 12. After the silicone rubber and the colored rotation spherical materials in two colors of black and white were mixed at a volume ratio of 1:1, and were formed as a sheet form. The sheet was degassed, and then was hardened for 48 hours at room temperature. The sheet was immersed into the translucent liquid (the silicone oil), and was left for twelve hours so as to swell by absorbing oil, and consequently the translucent liquid was provided around the colored rotation spherical materials. Transparent sheets on which ITO transparent electrodes had been vapor-deposited were brought in close contact with the top and bottom surfaces of the sheet base material 11 manufactured in this way, and consequently the spherical materials in the sheet base material became rotational.

When a voltage was applied on the sheet base material 11 so as to face the white side of the colored rotation spherical materials toward an observing person, white display with extremely high whiteness degree and reflectance compared with a display without the reflective layer 3 was realized.

As described above, with the present embodiments, introducing the optical reflective layer 3 into the colored rotation spherical materials for the sheet-type display device using two-colored rotation balls increases the reflectance of white. This means that colored rotation spherical materials with a small diameter for increasing resolution of a display can provide sufficient reflectance of white. Additionally, with the present embodiments, since the concentration of white pigment can be reduced when a colored rotation spherical material with the reflective layer is used to provide the same reflectance of white as a two-colored spherical material without the reflective layer is used, it is possible to improve weight balance between white and black relating to display characteristics.

The present invention provides a colored rotation spherical material which enables securing sufficient lightness even when the diameter of the spherical material is reduced, a manufacturing method for a colored rotation spherical material which makes borders between individual colored parts and a reflective material clearly distinct, and simultaneously controls volume ratio among the individual colored parts and the reflective material, and a display device which uses this colored rotation spherical material as a display element for increasing the resolution of a displayed image.

What is claimed is:

1. A colored rotation spherical material for rotating under influence of an electric field so as to present a surface with a corresponding color, said spherical material comprising:
multiple regions on a surface different from one another in color and electrostatic property; and
an optical reflective region inside for enhancing reflection from the inside in one region of said multiple regions.

2. The colored rotation spherical material according to claim 1, wherein said reflective region is formed such that a reflective layer is held between a first part and a second part constituting said individual colors.

3. The colored rotation spherical material according to claim 2, wherein said reflective layer is constituted by multiple laminated films.

4. The colored rotation spherical material according to claim 2, wherein said reflective layer is a metal film.

5. The colored rotation spherical material according to claim 2, wherein said reflective layer is formed by diffusing metal fine spherical materials in resin.

6. The colored rotation spherical material according to claim 2, wherein said reflective layer has a refractive index different from those of said parts in two colors.

7. A manufacturing method for a colored rotation spherical material having a surface defined into two regions different from each other in color and electrostatic property, and rotating under influence of an electric field so as to present the surface with a corresponding color, said method comprising the steps of:
preparing two thermoplastic resin sheets different from each other in color;
forming an optical reflective material on one surface of at least one of said thermoplastic resin sheets;
forming a multilayer resin sheet by integrally adhering said two thermoplastic resin sheets to each other so as to hold said reflective material between them;
cutting said multilayer resin sheet into chips, and
applying heat treatment to said chip-shape cut piece to form a sphere.

8. The manufacturing method for a colored rotation spherical material according to claim 7, wherein said reflective material is a metal film, and said metal film is formed by vapor deposition on the one surface of at least one of said thermoplastic resin sheets.

9. The manufacturing method for a colored rotation spherical material according to claim 8, wherein said metal film is constituted by multiple laminated films.

10. A manufacturing method for a colored rotation spherical material having a surface divided into two regions different from each other in color and electrostatic property, and rotating under influence of an electric field so as to present the surface with a corresponding color, said method comprising the steps of:
forming a reflective resin sheet by diffusing fine metal spherical materials in thermoplastic resin;
preparing two thermoplastic resin sheets different from each other in color;
forming a multilayer resin sheet by integrally adhering said two thermoplastic resin sheets to each other so as to hold said reflective resin sheet between them;
cutting said multilayer resin sheet into chips, and
applying heat treatment to said chip-shape cut piece to form a sphere.

11. The manufacturing method for a colored rotation spherical material according to claim 10, wherein said thermoplastic resin constituting said reflective resin sheet is compatible with said two thermoplastic resin sheets.

12. A display device comprising:
a pair of opposing electrode substrates including at least one transparent electrode substrate; and
a disperse system sealed between said pair of opposing electrode substrates, said disperse system including a colored rotation spherical material,
wherein said colored rotation spherical material comprises multiple regions on a surface different from one another in color and electrostatic property, and an optical reflective region inside for enhancing reflection from the inside in one region of said multiple regions, and the spherical material rotates under influence of an electric field so as to present a surface with a corresponding color.
